(19) United States
(12) Patent Application Publication
(10) Pub. No.: US 2003/0117132 A1
(43) Pub. Date: Jun. 26, 2003

(54) Contactless sensing input device

(76) Inventor: Gunnar Klinghult, Lund (SE)

Correspondence Address: JENKENS & GILCHRIST, P.C., 3200 Fountain Place, 1445 Ross Avenue, Dallas, TX, 75202-2799, US

(21) Appl. No.: 10/154,252

(22) Filed: May 23, 2002

Related U.S. Application Data
(60) Provisional application No. 60/342,982, filed on Dec. 21, 2001.

(51) Int. Cl. G01B 7/30; G01P 3/52

(52) U.S. Cl. 324/207.25; 324/207.22; 324/165

(57) ABSTRACT

A user input apparatus and method for providing control for an electronic device uses contactless sensing. The user input device includes a substantially circular disk having at least one ferromagnetic plate located adjacent to a periphery of the disk and coupled to the disk. The input device also includes a magnet and a magnetic sensor adjacent to the magnet and with magnetic sensor's sensitivity axis oriented parallel to the magnet. The magnet and the magnetic sensor are situated near the periphery of the disk on a circuit board such that, as the disk is rotated, the ferromagnetic plates coupled to the disk pass within a predetermined distance from the magnet but do not contact the magnet or the magnetic sensor. The magnetic sensor outputs a signal when the at least one ferromagnetic plate passes within the predetermined distance from the magnet. The input device is also configured to enable a user to detect a rotational resistance of the disk when the ferromagnetic plate passes within the predetermined distance from the magnet, thereby providing a tactile feedback to the user of the input device.

### CROSS REFERENCE TO RELATED APPLICATION

The present application for patent is related to and hereby claims priority from and incorporates by reference the subject matter disclosed in U.S. Provisional Patent Application Serial No. 60/342,982 filed on Dec. 21, 2001.

### BACKGROUND OF THE INVENTION

1. Technical Field of the Invention

The present invention relates generally to user interfaces for electronic devices and, in particular, to a rotating disk input device having contactless sensing and tactile feedback.

2. Description of Related Art

Controllers and input devices within electronic, equipment provide control for various operations of the electronic equipment such as navigation through menus. Input devices are of different configurations, depending on the electronic equipment and the desired functions of the user interface. A conventional input device that is used in mobile phones and other electronic equipment is a joystick controller. As the name indicates, the input device is formed of a protruding arm member that may be moved in any direction to navigate a menu or to perform any other function. For example, the joystick's protruding arm may be moved upwards resulting in a contact with a conducting member within the base of the joystick. This contact will generate a signal that enables a certain function, i.e., scrolling up a menu. The downward movement of the joystick's protruding arm will enable the joystick to perform a similar function, i.e., scrolling down the menu.

Another widely used input device is a circular disk type device. This input device has a circular disk which may be turned back and forth to perform control functions, i.e., scroll through menus, within the electronic equipment. Conventionally, the circular disk contains a plurality of electric contacts thereon that are configured to contact at least one electric terminal external to the disk, thus closing a circuit, which produces a signal used to control the electronic equipment. In other words, the plurality of electric contacts will slide over the electric terminal and will generate a signal when each electric contact contacts the electric terminal. This generated signal is then used in a control operation, such as scrolling up/down a menu.

A problem with the circular disk having the electric contacts sliding over the electric terminal is mechanical wear. The sliding electric contacts will be in mechanical contact with the electric terminal and will be subject to mechanical wear, thus reducing the efficiency of the electric contacts and eventually causing partial or complete failure. Moreover, dust and moisture may affect both the electrical and mechanical components of the input device, leading to an undesired deterioration in the control/navigation operation of the input device.

In view of the foregoing, there is a need for an input device that is constructed so as to reduce or eliminate the electrical and mechanical wear of the components within the input device as well as improve the performance of the input device and still have tactile feedback.

### SUMMARY OF THE INVENTION

The present invention relates to a user input apparatus and method for use in an electronic device. The user input device includes a substantially circular disk having at least one ferromagnetic plate located adjacent to a periphery of the disk and coupled to the disk. The input device also includes a magnet and a magnetic sensor adjacent to the magnet and with the magnetic sensor's sensitivity axis oriented parallel to the magnet. Preferably, the magnet and the magnetic sensor are situated near the periphery of the disk on a circuit board such that, as the disk is rotated, the ferromagnetic plates coupled to the disk pass within a predetermined distance from the magnet but do not contact the magnet or the magnetic sensor. The magnetic sensor outputs a signal when the at least one ferromagnetic plate passes within a predetermined distance from the magnet. The input device is also configured to enable a user to detect a rotational resistance of the disk when the ferromagnetic plate passes within the predetermined distance from the magnet, thereby providing a tactile feedback to the user of the input device.

In an alternative embodiment, the input device includes a plurality of magnets and magnetic sensors that are configured in such a way as to enable detection of the rotational direction of the circular disk.

### BRIEF DESCRIPTION OF THE DRAWINGS

For a more complete understanding of the present invention, reference is made to the following detailed description taken in conjunction with the accompanying drawings wherein:

FIG. 1 is a top view of the input device in accordance with one embodiment of the present invention;

FIG. 2 is a side view of the input device along lines 2-2 of FIG. 1;

FIG. 3 is a cross sectional view of the input device along lines 3-3 of FIG. 1;

FIG. 4A is a top view of the input device in accordance with an alternative embodiment of the present invention;

FIG. 4B is a timing diagram illustrating the signals generated by the input device of FIG. 4A; and

FIG. 5 is a flow diagram illustrating the operation of the input device of FIG. 1.

### DETAILED DESCRIPTION OF THE INVENTION

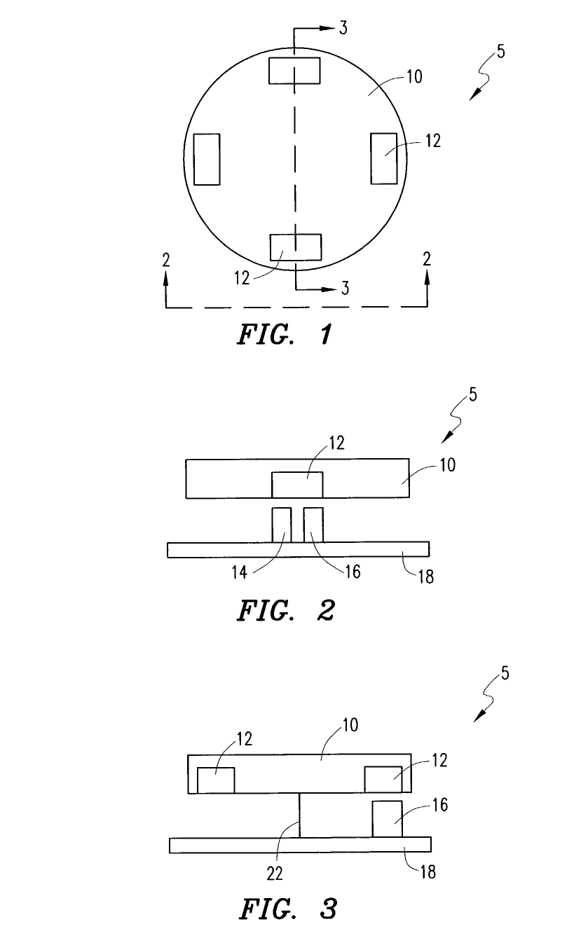

Reference is now made to the Drawings wherein like reference numerals denote like or similar parts throughout the various Figures. Although the innovative teachings of the present application are described with reference to particular embodiments, it should be understood that the embodiments described herein provide only a few examples of the many advantageous uses of the innovative teachings herein. Referring now to FIGS. 1, 2, and 3, there is illustrated a top view, a side view, and a cross sectional view, respectively, of an input device 5 according to an exemplary embodiment of the present invention. The input device 5 can be used in a mobile phone or any other electronic equipment requiring support for navigation or control. The input device 5 includes a substantially circular disk 10 that is constructed of a non-ferromagnetic material. The circular disk 10 includes a plurality of ferromagnetic plates 12 attached thereto or incorporated therein along the periphery of the circular disk 10. The ferromagnetic plates 12 can be disposed on one side of the circular disk 10, disposed within the circular disk 10, or externally protruding from the circular disk 10. The ferromagnetic plates 12 can be fabricated from any ferromagnetic material, such as steel. The circular disk 10 is mounted on a printed circuit board (PCB) 18 or secured to any component within the electronic device using a support member 22 in such a way as to allow rotation of the circular disk 10. Generally, the support member 22 is rotatably coupled to the central axis of the circular disk 10, i.e., the center of gravity of the disk, to enable balanced rotation of the circular disk 10.

The input device 5 includes therein a magnet 14 and a magnetic sensor 16 (e.g., a hall sensor) disposed on the PCB 18 and situated adjacent to the periphery of the circular disk 10. The magnetic sensor 16 has a specified sensitivity axis. The magnetic sensor 16 outputs a signal when it reaches its hysteresis level. This implies that when the magnetic field, as described hereinafter, exceeds a minimum level, the magnetic sensor 16 outputs the signal. The magnet 14 is positioned to attract each ferromagnetic plate 12 when the plate 12 is within a predetermined distance from the magnet 14. The magnetic sensor 16 is situated on the PCB 18 adjacent to the magnet 14 and with its sensitivity axis oriented parallel to the magnet's 14 north-to-south pole such that, when the plate 12 passes within a predetermined distance from the magnetic sensor 16, the magnetic sensor 16 generates a signal that is provided to a microcontroller (not shown) of the electronic device. In response to the signal, the microcontroller can, for example, effectuate a scrolling operation on a display screen of the electronic device. More specifically, when the plate 12 passes over the magnet 14/magnetic sensor 16 combination, the magnetic field between the plate and the magnet 14/magnetic sensor 16 combination becomes concentrated and increases. The air gap between the magnet 14 and the plate 12, which corresponds to the magnetic resistance (i.e., reluctance), decreases. In response to the concentration of the magnetic field, the magnetic sensor 16 generates a detectable signal.

The circular disk 10 is positioned such that a gap separates the circular disk 10 and the associated ferromagnetic plate 12 from the magnet 16 and the magnetic sensor 16. This gap will enable rotation of the circular disk 10 without contacting the magnet 14 and the magnetic sensor 16. Moreover, when the ferromagnetic plate 12 passes over the magnet 14 and the magnetic sensor 16, the magnetic field is concentrated across the gap, and there is no need to have any contact between the plate 12 and the magnet 14 or the magnetic sensor 16. It should be understood that the gap can be of any distance that enables the attraction between the magnet 14 and the plate 12 to provide enough concentration of the magnetic field to activate the magnetic sensor 16.

When the ferromagnetic plate 12, magnet 14, and magnetic sensor 16 form the concentrated magnetic field, the magnetic sensor 16 outputs a signal through the PCB 18 to another component connected to the PCB 18, such as a microcontroller (not shown). The microcontroller may control the navigation of a menu and display the results on a screen, i.e., LCD screen (not shown). However, it should be understood that the signal produced by the magnetic sensor 16 can be used in any desired control application.

During the rotation of the circular disk 10 and when one of the ferromagnetic plates 12 within the circular disk 10 passes over the magnet 14 and the magnetic sensor 16, an attractive force between the magnet 14 and the plate 12 is applied to the circular disk 10 which results in a rotational resistance, i.e., slight stopping, of the circular disk 10. This rotational resistance provides a tactile feedback to the user of the input device corresponding to a certain operation/function being performed due to the signal generated by the magnetic sensor 16. The tactile feedback due to the attraction between the magnet 14 and the ferromagnetic plate 12 allows the user of the input device 5 to feel the rotational resistance and thus provide the user with a feeling of the operation of the input device 5. For example, this operation can be scrolling through a menu and during each step of the scroll through the menu, the user feels a rotational resistance (i.e., stopping) indicative of one step of the scroll through the menu. The user will feel multiple rotational resistance feedbacks if the user rapidly scrolls through multiple entries of the menu, each rotational resistance feedback corresponding to one step.

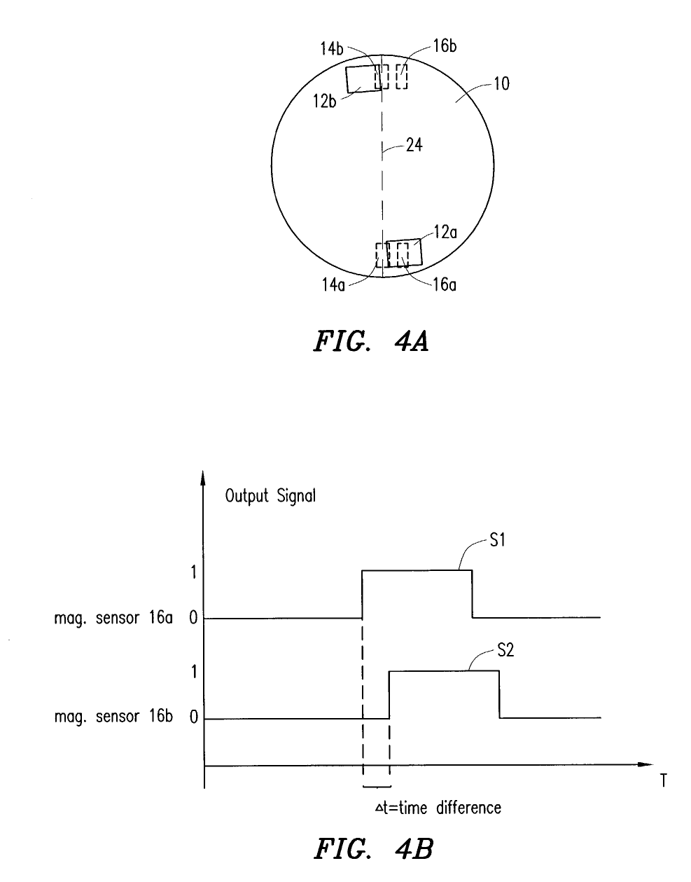

Referring now to FIGS. 4A and 4B, there is illustrated an alternative embodiment of the input device 5 of the present invention and a timing diagram of the signals generated by the input device 5 of the alternative embodiment, respectively. The input device 5 of this alternative embodiment is essentially the same as described in connection with FIGS. 1-3. In this embodiment, however, the input device 5 has at least two magnets 14a and 14b and at least two magnetic sensors 16a and 16b. Each magnetic sensor 16a or 16b is located adjacent to, and with its sensitivity axis oriented parallel to, the magnet 14a or 14b associated therewith. The magnets 14a and 14b can be symmetrically placed adjacent to the periphery of the circular disk 10 (i.e., on opposite ends of the disk) so that the attracting force from the magnets 14 on the ferromagnetic plate 12 will not cause an unbalanced force on, or rotation of the disk 10. The magnetic sensors 16a and 16b are located adjacent to the magnets 14a and 14b, respectively, and are placed asymmetrically with respect to each other. In other words, the magnetic sensors 16a and 16b are located on one side of the axis of the circular disk 10. The magnetic sensors 16a and 16b are located such that, during the rotation of the circular disk 10, a first plate 12a comes within a predetermined distance from the first magnet sensor 16a before a second plate 12b on the opposite end of the circular disk 10 comes within the predetermined distance from the second magnet sensor 16b.

As the circular disk 10 is rotated, a first ferromagnetic plate 12a passes within a predetermined distance from the first magnet 14a and is thus attracted thereto. A first signal (S1) is then generated by the first magnetic sensor 16a (i.e., a high logic value appearing on the output of the first magnetic sensor 16a) due to the creation of a concentrated magnetic field, as described hereinabove. At the same time, a second ferromagnetic plate 12b that is symmetrical to the first plate 12a is in proximity to the second magnet 14b and is attracted thereto. However, a concentrated magnetic field has not been created (i.e., the magnetic field has not exceeded the minimum level necessary to generate a signal) due to the location of the second magnetic sensor 16b being asymmetrical to the first magnetic sensor 16a. Upon further rotation of the disk 12, the second ferromagnetic plate 12b passes over the second magnet 14b and a concentrated magnetic field is created between the second magnet 14b and the second ferromagnetic plate 12b which results in the generation of a second signal (S2) by the second magnetic sensor 16b (i.e., a high logic value appearing on the output of the second magnetic sensor 16b).

This configuration enables the second magnetic sensor 16b to generate the second signal (S2) relatively soon after the first magnetic sensor 16a generates the first signal (S1). The rotational direction of the circular disk 10 can then be determined based on the sequence in which the first and second magnetic sensors 16a and 16b generate the first (S1) and second (s2) signals. For example, if the generation of the first signal (S1) by the first magnetic sensor 16a is followed by the generation of the second signal (S2) by the second magnetic sensor 16b, it can be determined that the rotation of the circular disk 10 is in a first direction (e.g., clockwise). On the other hand, if the second signal (S2) is generated prior to the first signal (S1), it can be determined that the rotation of the circular disk is in a second direction (e.g., counterclockwise).

It should be understood that the tactile feedback provided to the user of the input device 5 operates in the same way as described hereinabove by providing a rotational resistance when the ferromagnetic plate is in proximity to the magnet 14. In a preferred embodiment, the time difference (Δt) between the first signal (S1) generated by the first magnetic sensor 16a and the second signal (S2) generated by the second magnetic sensor 16b, is small enough in order for the user to feel that the two attractions between the two magnets 14a and 14b and the two plates 12a and 12b, are just a single attraction. This creates a single tactile feedback to the user indicative of the signal produced to perform the desired function while still enabling the input device to determine the rotational direction of the circular disk 10.

It should be understood that other implementations of determining the rotational direction of the circular disk 10 are possible. For example, at least two magnets 14a and 14b and at least two magnetic sensors 16a and 16b could be positioned such that, as the circular disk 10 is rotated, the second magnetic sensor 16b begins generating a signal before the first magnetic sensor 16a ceases generating a signal (i.e., due to the ferromagnetic plate being wide enough to produce a concentrated magnetic field involving both magnetic sensors 16a and 16b). Based on which magnetic sensor 16a or 16b began generating a signal first, the rotational direction can be determined. Moreover, such a configuration would help avoid potentially erroneous determinations of rotational direction that could occur in the previous configuration when the direction of rotation is changed after only one of the magnetic sensors 16a or 16b detects a concentrated magnetic field.

In another alternative, a single or multiple magnet/magnetic sensor pairs could be used in connection with different ferromagnetic plate 12 thicknesses, which results in different magnetic field strengths when one of the plates forms a concentrated magnetic field with the magnet 14 and the magnetic sensor 16. Based on the magnetic field strength, the signal strength generated by the magnetic sensor 16 could be different. In this case, the rotational direction of the disk 10 could be determined by comparing the previous signal strength to the current signal strength.

It should be understood that having several ferromagnetic plates 12 placed on the periphery of the circular disk 10 can increase the resolution of the scrolling operation. Thus the number of steps performed by a complete rotation of the circular disk 10 can be increased when there are more plates 12 on the circular disk 10. For example, if the circular disk 10 has four ferromagnetic plates 12, then a signal can be generated at each quarter of a turn. Increasing the number of ferromagnetic plates 12 thereby decreases the number of rotations needed for a user to scroll through a menu.

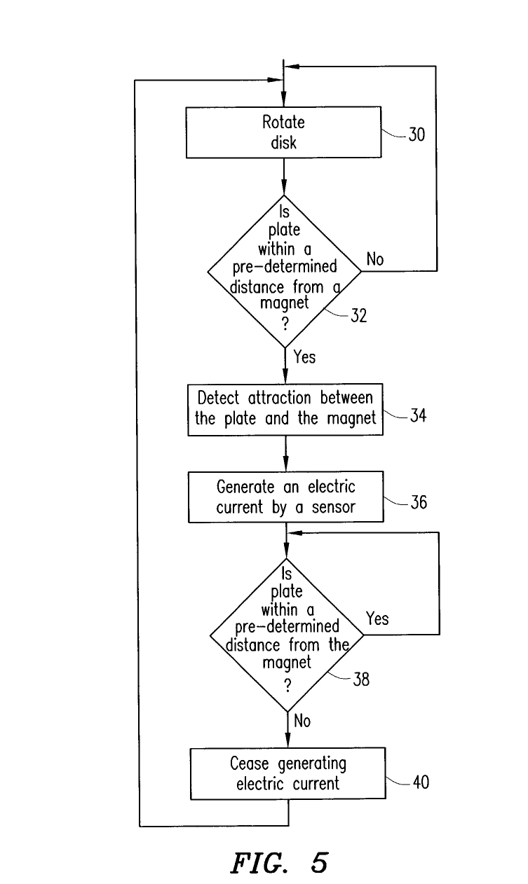

FIG. 5 is a flow diagram illustrating the operation of the input device 5 of the exemplary embodiment of FIGS. 1, 2, and 3. Initially, it is assumed that the input device 5 is in an inactive state (i.e., no signal is being generated). Subsequently, a disk 10 within the input device 5 is rotated at step 30 indicating a desire to perform a function, such as scrolling through a menu. As the disk 10 is rotated, if it is determined at step 32 that a ferromagnetic plate 12 included in the disk 10 is within a predetermined distance from a magnet 14, an attraction between the plate 12 and the magnet 14 is detected at step 34. If the disk 10 is not rotated by a sufficient amount to cause the ferromagnetic plate 12 to be within the predetermined distance from the magnet 14, then an attraction is not detected; instead, the process returns to step 30 to await additional rotation of the disk 10.

When the attraction of the plate 12 to the magnet 14 does form a concentrated magnetic field with the magnet 14 and a magnetic sensor 16, the concentrated magnetic field enables the magnetic sensor 16 to begin generating an electric current/signal at step 36. This electric current/signal can be used to perform a control operation, i.e., scroll up/down a menu. As long as the ferromagnetic plate 12 remains within the predetermined distance from the magnet 14, the electric current/signal continues to be generated. Accordingly, at step 38, it is determined whether the ferromagnetic plate 12 has moved outside of the predetermined distance from the magnet 14. If not, the magnetic sensor 16 continues to generate the electric current/signal. However, once the ferromagnetic plate 12 is determined at step 38 to have moved outside of the predetermined distance (i.e., through additional rotation of the disk 10), the generation of the electric current/signal ceases at step 40, and the process returns to step 30. The process can be repeated, using one or more magnets and/or using one or more ferromagnetic plates, any number of times to, for example, navigate through a menu, whereby each signal enables a scrolling step in the menu.

Although exemplary embodiments of the method and apparatus of the present invention has been illustrated in the accompanying Drawings and described in the foregoing Detailed Description, it is understood that the invention is not limited to the embodiments disclosed, but is capable of numerous rearrangements, modifications, and substitutions without departing from the spirit of the invention as set forth and defined by the following claims.

What is claimed is:

1. A user input apparatus for an electronic device, comprising:
a rotatable, substantially circular disk;
at least one ferromagnetic plate located adjacent to a periphery of said disk and coupled to said disk;
a magnet;
a magnetic sensor adjacent to said magnet and oriented magnetically parallel to said magnet; and
wherein said magnet and said magnetic sensor are situated near the periphery of said disk such that, as said disk is rotated, the magnetic sensor outputs a signal when said at least one ferromagnetic plate passes within a predetermined distance from said magnet.

2. The user input apparatus of claim 1, wherein a magnetic force between said at least one ferromagnetic plate and said magnet causes a rotational resistance that is detectable by a user when said at least one ferromagnetic plate passes within said predetermined distance from said magnet as said user rotates the disk.

3. The user input apparatus of claim 1, further comprising a plurality of ferromagnetic plates located along the periphery of and attached to said disk.

4. The user input apparatus of claim 1, further comprising:
a plurality of magnets;
a plurality of magnetic sensors, each magnetic sensor adjacent to, and with its sensitivity axis oriented parallel to, a corresponding magnet; and
wherein each magnet and each corresponding magnetic sensor are situated near the periphery of said disk.

5. The user input apparatus of claim 1, wherein at least one of the magnet and the magnetic sensor are coupled to a circuit board.

6. The user input apparatus of claim 1, wherein the magnetic sensor outputs said signal responsive to a concentrated magnetic field formed by at least the magnet, the magnetic sensor, and the at least one ferromagnetic plate.

7. The user input apparatus of claim 1, wherein the circular disk is configured to provide a contactless operation with the magnet and the magnetic sensor.

8. The user apparatus of claim 7, wherein said magnetic sensor outputs the signal without contacting said at least one ferromagnetic plate.

9. The user input apparatus of claim 1, further comprising:
a second magnet; and
a second magnetic sensor adjacent to said second magnet, wherein said second magnet and said second magnetic sensor are situated near the periphery of said disk in proximity to the magnet and the magnetic sensor such that, as said disk is rotated, the direction of rotation of the disk is determined based on which magnetic sensor outputs the signal first.

10. The user input apparatus of claim 1, wherein the electronic device is a mobile phone.

11. A method for the operation of an input device, said method comprising the steps of:
rotating a circular disk having ferromagnetic plates thereon;
generating an electric signal when one of the ferromagnetic plates is within a predetermined distance from a magnet; and
performing a control operation in an electronic device responsive to the signal.

12. The method of claim 11, wherein the step of generating comprises generating the signal in response to a detection of a concentrated magnetic field between the magnet and said one of the ferromagnetic plates, said detection performed without providing contact between the magnet and said one of the ferromagnetic plates.

13. The method of claim 11, further comprising the step of:
providing a rotational resistence opposing the rotation of the circular disk when one of the ferromagnetic plates is within the predetermined distance from the magnet.

14. The method of claim 11, further comprising the step of:
determining a rotational direction of the circular disk using a plurality of magnets.

15. The method of claim 11, further comprising, prior to the step of generating, the step of:
forming a concentrated magnetic field between one of the ferromagnetic plates, the magnet, and a magnetic sensor.

16. The method of claim 15, wherein the step of forming further comprises forming the concentrated magnetic field without providing a physical contact between said one of the ferromagnetic plates and the magnet and the magnetic sensor.
